(19) United States
(12) Patent Application Publication
(10) Pub. No.: US 2010/0323598 A1
(43) Pub. Date: Dec. 23, 2010

(54) APPARATUS TO AID IN THE EVISERATION OF FOOD ANIMALS AND METHOD FOR ITS USE

(76) Inventor: Russell Lowell, Bothel, WA (US)

Correspondence Address: Karr Tuttle Campbell;ATTN: PRIYA SINHA CLOUTIER, 1201 Third Ave., Ste 2900, Seattle, WA, 98101, US

(21) Appl. No.: 12/490,176

(22) Filed: Jun. 23, 2009

(51) Int. Cl. A22B 5/00

(52) U.S. Cl. 452/109; 452/107

(57) ABSTRACT

The current invention is an apparatus that can be used by hunters or slaughterhouses to reduce the risk of contamination during evisceration of an animal.

### CROSS-REFERENCES TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND

Generally, to eviscerate an animal for human consumption there are a certain set of steps that are taken. First, the animal is stunned or shot, then the arteries in the neck are severed so that the animal bleeds out. The carcass is then split down the center with a knife exposing its internal organs.

In the process above, there are several places where a simple slip of the knife can cause the meat to become tainted. A hunter with cold fingers or little patients may waste the meat of an entire animal when his knife slips.

Commercially, approximately 60,000 pounds of meat per week is thrown out because an animal is improperly slaughtered. Meat is wasted and profits are lost. Commercial slaughterhouses also employ a laboratory to sample slaughtered meat in case of accidental contamination as an animal passes through; this is another large expense.

In some cases, the tainted meat is sold at a lower price. The contaminated meat is then radiated or cooked to kill bacterial contamination. It is yet unknown how the radiation may affect the meat or how eating radiated meat may affect humans. If the meat is improperly cooked, disaster is certain.

The current invention is an apparatus that can be used by hunters or slaughterhouses to reduce the risk of contamination caused by accidental cutting of the colon; this is where an animal could potentially shed the E.coli O157 bacteria. The apparatus is inserted around the anus of the animal and pushed through until it stops at the end of the pelvic bone. When inserted into the animal, the apparatus serves as a sleeve to protect the integrity of the colon. The pelvic bone can then be split without the possibility of breaking into the colon. The apparatus will also lessen the time it takes for an animal to be slaughtered. Consequently, slaughterhouses will become more efficient.

### BRIEF SUMMARY OF THE INVENTION

The current invention is an apparatus that can be used by hunters or slaughterhouses to reduce the risk of contamination during slaughter of an animal.

### BRIEF DESCRIPTION OF THE DRAWINGS

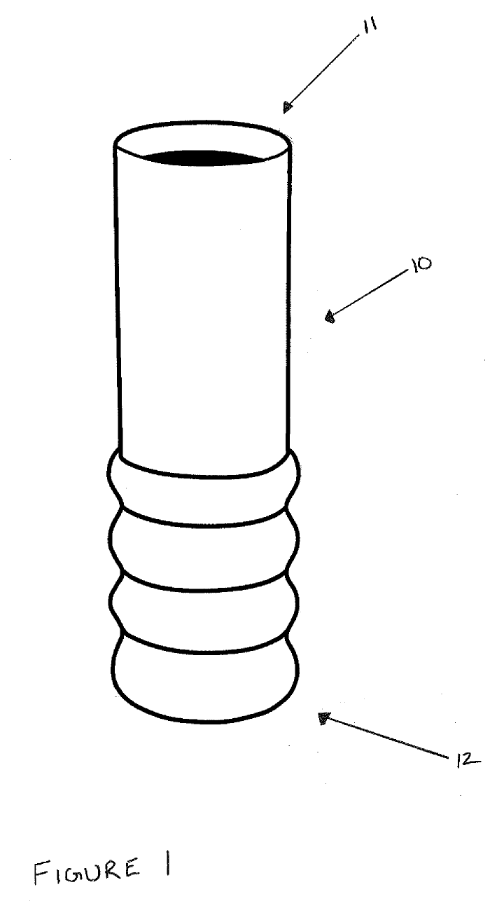

Other features and advantages of the present invention will become apparent in the following detailed descriptions of the preferred embodiment with reference to FIG. 1 which is an elevational view of the apparatus.

### DETAILED DESCRIPTION OF THE INVENTION

The apparatus is described more fully hereinafter with reference to the accompanying drawings, in which preferred embodiments of the invention are shown.

This invention may, however, be embodied in many different forms and should not be construed as limited to the embodiments set forth herein; rather, these embodiments are provided so that this disclosure will be thorough and complete and will fully convey the scope of the invention to those skilled in the art.

The apparatus comprises of a rigid, hollow cylinder (10). In the preferred embodiment, the cylinder (10) is made from metal or other material that can withstand the blade of a knife.

The cylinder (10) further comprises a distal end (11) and near end (12). The distal end (11) defines a sharp cutting edge. The near end (12) can beveled so that the cylinder can be easily grasped by the user. Alternatively, the near end (12) can comprise a slip proof material such as rubber. The near end (12) can also comprise a handle.

The radius and length of the cylinder (10) is dependent on the animal being slaughtered. For example, to eviscerate a lamb or pig, the apparatus will, optimally, have a diameter of 2″ and a length of 6″. Cattle will require an apparatus that has a diameter of anywhere from 4″ to 6″ and a length of 12″ to 14″. It will become obvious to one skilled in the art that the diameters and lengths provided above are merely examples. The apparatus' diameter and length is proportional to the size of the animal that is being eviscerate.

To use the apparatus, the user positions the animal so that is ready to be butchered. The apparatus is then inserted around the animal's anus. The distal end (11) is inserted first. As the apparatus is inserted, the sharp cutting end will loosen the muscles around the colon.

The apparatus is completely inserted when the user feels the pelvic bone. When the apparatus is completely inserted, it will cover the colon and stop at the bladder. Consequently, the pelvic bone can be split without fear of cutting the animal's colon and the pelvic bone can be split without fear of cutting through the colon. Once the animal is split, the intestines are easily removed because the pelvic bone is now open, allowing easy access to the colon and the connective tissue holding it in place.

What is claimed is:

1. An apparatus that ensconces an animal's colon to protect the colon from accidental tear during evisceration; said apparatus comprising:
a rigid, hollow cylinder where said cylinder comprises a near end and a distal end;
said distal end defines a sharp cutting edge;
said near end comprises a means to prevent a user's hand from slipping when using the apparatus.

2. (canceled)

3. (canceled)

4. (canceled)

5. (canceled)

6. A method to use the apparatus of claim 1 on an animal being eviscerated comprising:
inserting the distal end around the animal's anus during evisceration;
completing insertion when the apparatus strikes said animal's pelvic bone.
